(19) United States
(12) Patent Application Publication
(10) Pub. No.: US 2019/0253271 A1
(43) Pub. Date: Aug. 15, 2019

(54) CONTROL SYSTEM

(71) Applicants: LUCIS TECHNOLOGIES (SHANGHAI) CO., LTD., Shanghai (CN); LUCIS TECHNOLOGIES HOLDINGS LIMITED, Grand Cayman (KY)

(72) Inventors: Defeng SHI, Shanghai (CN); Lin ZHOU, Shanghai (CN); Shan GUAN, FREMONT, CA (US); Tao ZHAO, Shanghai (CN)

(73) Assignees: LUCIS TECHNOLOGIES (SHANGHAI) CO., LTD., Shanghai (CN); LUCIS TECHNOLOGIES HOLDINGS LIMITED, Grand Cayman (KY)

(21) Appl. No.: 16/326,701

(22) PCT Filed: Aug. 19, 2016
(86) PCT No.: PCT/CN2016/096095

§ 371 Date: Feb. 19, 2019

(51) Int. Cl. H04L 12/28; G05D 23/19

(52) U.S. Cl. CPC H04L 12/2816; H04L 12/2814; G05D 23/1928; G05D 23/1902

(57) ABSTRACT

The present disclosure relates to an intelligent home control system and method relating to feedback adjustments and power management techniques. In the process for implementing the system and method, firstly, data information may be received by the data receiving module. Secondly, the received data information may be analyzed by the processing module. Different control information may be generated based on the analysis and processing result of the data information, according to adjustment modes of operation states of different devices. Again, the control information may be transmitted via a wireless communication module. Then, the operation state of a corresponding device may be separately controlled and adjusted by the adjustment module. At the same time, the power source management module may manage power supply of modules and devices in the system.

### TECHNICAL FIELD

This disclosure generally relates to a control system, and more particularly, to an intelligent control system relating to feedback adjustments and power management techniques and a method thereof.

### BACKGROUND

Intelligent home is an embodiment of Internet of Things (IoT) under the influence of the Internet. The intelligent home connects various devices (e.g., an audio and video device, a lighting system, a security system, a digital cinema system, a video server, a network appliance, etc.) together in the home through IoT technology, and provide various functions and means for, e.g., home appliance control, lighting control, telephone remote control, indoor and outdoor remote control, anti-theft alarm, environment monitoring, heating and ventilation (HVAC) control, infrared repeating and programmable timing control. An intelligent home system takes domestic appliances and appliances as main control objects. The intelligent home system may integrated home-related facilities efficiently using integrated wiring technology, network communication technology, security technology, automatic control technology, audio and video technology, and build efficient control systems for residential facilities and daily family schedules, thereby enhancing intelligence, safety, convenience, comfort of home, and implementing an environmentally friendly control system platform. Compared with ordinary home, the intelligent home not only has traditional living functions, but also has construction, network communication, information appliance, device automation, and provides an all-around information interaction function.

### SUMMARY

In some embodiments, a system is provided. The system may include a data receiving module, a processing module, an adjustment module, and a power source management module. The data receiving module may receive data. The data may be related to operation of a first device. The processing module may process the data to produce processed data. The adjustment module may generate a control instruction according to the processed data. The control instruction may adjust the operation of the first device. The power source management module may manage a power source of a first module or a power source of the first device in the system. The system may further include a wireless communication module. The wireless communication module may communicate with the first device or a second device wirelessly.

In some embodiments, a method is provided. The method may include receiving data by a data receiving module. The data may be related to operation of a first device. The method may further include processing the data to produce processed data by a processing module. The method may further include generating a control instruction based on the processed data by an adjustment module. The control instruction may adjust the operation of the first device. The method may further include managing a power source of a first module or a power source of the first device by a power source management module. The method may further include communicating with the first device or a second device wirelessly by a wireless communication module.

In some embodiments, a computer readable storage medium storing executable instructions is provided. The executable instructions may cause a computer device to receive data by a data receiving module. The data may be related to operation of a first device. The instruction may cause the computer device to process the data to produce processed data by a processing module. The instruction may cause the computer device to generate a control instruction based on the processed data by an adjustment module. The control instruction may adjust the operation of the first device. The instruction may cause the computer device to manage a power source of a first module or a power source of the first device by a power source management module.

In some embodiments, the data received by the data receiving module may be from a sensor.

In some embodiments, the sensor may include a sound sensor, a temperature sensor, a humidity sensor, a motion sensor, a brightness sensor or an energy consumption sensor.

In some embodiments, the temperature sensor may measure a temperature of the first module or a temperature of the first device in the system.

In some embodiments, the first module may include the processing module, the adjustment module, or the data receiving module.

In some embodiments, the first device may include one or more of: a humidifier, an air conditioner, an electric fan, an LED lamp, a mercury lamp, a halogen lamp, a metal halide lamp, and an incandescent lamp.

In some embodiments, the power source management module may be configured to provide a required voltage to the first module or the first device.

In some embodiments, the adjustment module may further include a power adjustment unit. The power adjustment unit may be configured to change the operation of the first device by adjusting an input power of the first device.

In some embodiments, the adjustment module may further include an other-device adjustment unit. The other-device adjustment unit may be configured to generate a second control instruction, and the second control instruction may adjust an operation mode of the second device.

In some embodiments, the second device may include an electrical appliance, an intelligent doorbell, an anti-theft device, an intelligent lighting device, an intelligent curtain, a boiler control device, a heating control device, a water tank level adjustment device, or an intelligent door lock.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

In order to illustrate the technical solutions related to the embodiments of the present disclosure clearly, brief introduction of the drawings referred to the description of the embodiments is provided below. Obviously, the drawings in the following description are only some examples of the present disclosure. For the skilled in the art, the present disclosure may be applied to other similar scenarios according to these drawings without any creative labor. Unless stated otherwise or obvious from the context, the same reference numeral in the drawings refers to the same structure and operation.

FIG. 1 is a schematic diagram illustrating an exemplary configuration of an intelligent control system according to some embodiments of the present disclosure;

FIG. 2 is a schematic diagram of an intelligent control system according to some embodiments of the present disclosure;

FIG. 3 is a flowchart illustrating an exemplary intelligent control system according to some embodiments of the present disclosure;

FIG. 4 is a schematic diagram illustrating an exemplary data receiving module according to some embodiments of the present disclosure;

FIG. 5A is a schematic diagram illustrating an exemplary adjustment module according to some embodiments of the present disclosure;

FIG. 5B is a schematic diagram illustrating an exemplary power adjustment unit according to some embodiments of the present disclosure;

FIG. 6 is a schematic diagram illustrating an exemplary lighting adjustment unit according to some embodiments of the present disclosure;

FIG. 7 is a schematic diagram illustrating an exemplary power source management module according to some embodiments of the present disclosure;

FIG. 8 is a schematic diagram illustrating an exemplary remote device according to some embodiments of the present disclosure;

FIG. 9A is a flowchart illustrating an exemplary process for generating a control instruction according to obtained data according to some embodiments of the present disclosure;

FIG. 9B is a flowchart illustrating an exemplary power adjustment according to some embodiments of the present disclosure;

FIG. 9C is a flowchart illustrating an exemplary adjustment of an other-device according to some embodiments of the present disclosure;

FIG. 10 is an exemplary flowchart illustrating an exemplary power management operation according to some embodiments of the present disclosure;

FIG. 11 is a circuit diagram illustrating a processing module according to some embodiments of the present disclosure;

FIG. 12 is a circuit diagram illustrating a wireless communication module according to some embodiments of the present disclosure;

FIG. 13 is a circuit diagram illustrating a power source management module according to some embodiments of the present disclosure;

FIG. 14A is a circuit diagram illustrating a sensor device according to some embodiments of the present disclosure;

FIG. 14B is a circuit diagram illustrating a sensor device according to some embodiments of the present disclosure;

FIG. 15 is a circuit diagram illustrating a power source management module and an adjustment module according to some embodiments of the present disclosure;

FIG. 16 is a circuit diagram illustrating a processing module according to some embodiments of the present disclosure; and

FIG. 17 is a circuit diagram illustrating a power source management module according to some embodiments of the present disclosure.

### DETAILED DESCRIPTION

As used in the disclosure and the appended claims, the singular forms “a,” “an,” and “the” include plural referents unless the content clearly dictates otherwise. The terms “including” and “comprising” are merely meant to include the steps and elements that are specifically identified, and such steps and elements do not constitute an exclusive list, and the method or device may also include other steps or elements. The term “based on” refers to “based at least in part on.” The term “one embodiment” refers to “at least one embodiment”; the term “another embodiment” refers to “at least one additional embodiment”. The relevant definitions of other terms will be given in the description below.

Some modules of the system are referred to in various ways according to some embodiments of the present disclosure, however, any number of different modules are used and operated in a client terminal and/or a server. The modules are illustrative only, and different aspects of the system and method are performed in different modules.

According to some embodiments of the present disclosure, flowcharts are used to illustrate the operation performed by the system. It is to be expressly understood, the operation above or below may or may not be implemented in order. Conversely, the operation may be performed in inverted order, or simultaneously. Besides, one or more other operations may be added to the flowcharts, or one or more operations may be omitted from the flowchart.

The method described in this specification includes receiving data information, analyzing the received data information, and processing the result based on the analysis of the data information, generating control information, and controlling and adjusting operation states of different devices. In some embodiments, the method described in the present specification also includes generating different control information according to the adjustment manners of the operation states of the different devices, and respectively control and adjust the operation states of the corresponding devices. In some embodiments, the present specification relates to an intelligent control system. The intelligent control system may include a data receiving module, a processing module, an adjustment module, a wireless communication module, and a power source management module.

The system and method described in the present disclosure is related to systems and methods described in International Patent Application No. PCT/CN2015/075923, entitled “Environmental Control System”, submitted on Apr. 3, 2015, International Patent Application No. PCT/CN2015/080160, entitled “Environmental Control System”, submitted on May 29, 2015 and International Patent Application No. PCT/CN2016/090975, entitled “Security System and Method”, submitted on Jul. 22, 2016, and these patent applications are incorporated herein by reference.

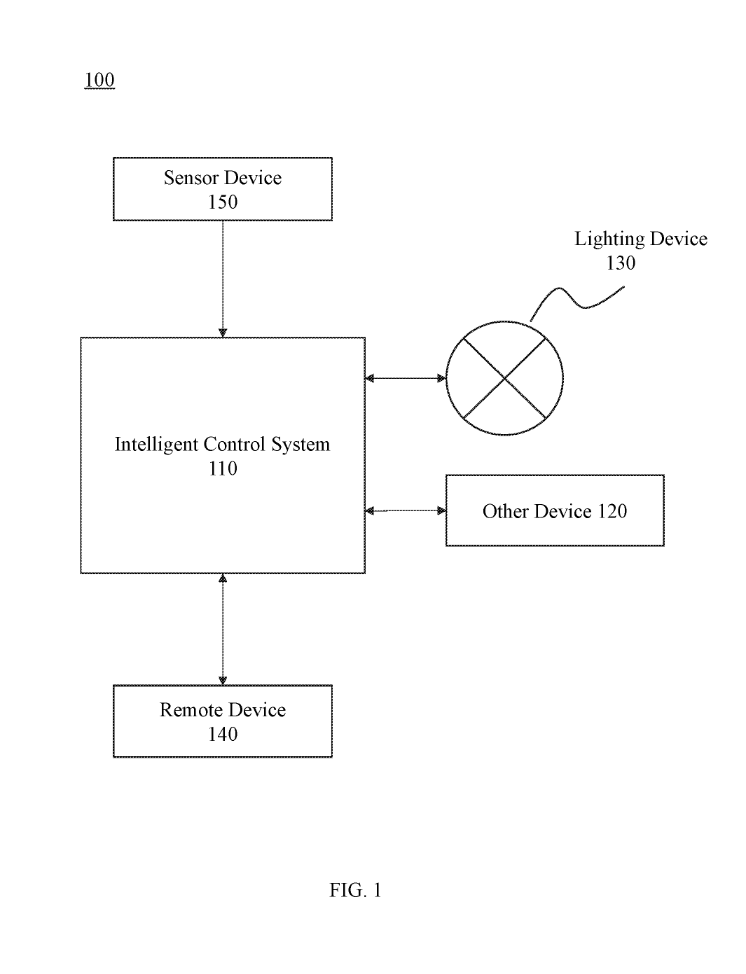

FIG. 1 is a schematic diagram illustrating an exemplary configuration of an intelligent control system according to some embodiments of the present disclosure. The system configuration 100 may include an intelligent management system 110, one or more other-devices 120, one or more lighting devices 130, one or more remote devices 140, and one or more sensor devices.

The intelligent control system 110 may be a system connected to each device. In some embodiments, the connection between the intelligent control system 110 and each device may be wired or wireless. In some embodiments, the connection between the intelligent control system 110 and each device may be bidirectional. In some embodiments, the intelligent control system 110 may receive sensor data obtained from the sensor device 150. The sensor data may include one or more of sound data, temperature data, humidity data, motion data, brightness data, and energy consumption data. In some embodiments, the intelligent control system 110 may analyze the received sensor data and detect abnormal data therein. Further, the intelligent control system 110 may control a sensor that has the abnormal data to perform multiple collections or adjust the sensor with abnormal data. In some embodiments, the intelligent control system 110 may generate one or more control information. The control information may be based on the obtained sensor data. In some embodiments, the control information may adjust operation states of the lighting device 130 and the remote device 140. In some embodiments, the intelligent control system may be an integrated chip or a circuit, e.g., a processor, etc. In some embodiments, the intelligent control system may include a plurality of sub-circuits.

Lighting device 130 may be any device that converts electrical energy into light energy. In some embodiments, the lighting device 130 may include, but is not limited to, one or more of a light-emitting diode (LED) lamp, a mercury lamp, a halogen lamp, a metal halide lamp, and an incandescent lamp. In some embodiments, the operation state of the lighting device 130 may be adjusted by the intelligent control system. The adjustment of the operational state may include, but is not limited to brightness adjustment, switch adjustment, light color adjustment (e.g., LED color change lamp with color change characteristics), lighting duration adjustment, flash frequency adjustment, or the like, or a combination thereof. In some embodiments, the brightness of the lighting device and the adjustment of the switch may be based on the input power of the lighting device. Further, the input power of the lighting device may be adjusted by the intelligent control system 110.

The other-device 120 may be any electrical device, e.g., air conditioners, televisions, refrigerators, etc. In some embodiments, operation states of the other-device 120 may be adjusted by the intelligent control system 110. In some embodiments, the adjustment of the operation states of the other-device 120 may be not directly adjusting an input power thereof. Instead, the operation state of the other-device 120 may be adjusted by receiving a control signal from the intelligent control system 110. According to different working characteristics of the other-device 120, the adjustment manner may be different. In some embodiments, the intelligent control system 110 may adjust the other-device 120 by a predetermined line or a predetermined module connected to the other-device 120. In some embodiments, the intelligent control system 110 may adjust the other-devices by a wireless signal, e.g., an infrared signal, a microwave signal, a radio wave signal, etc.

The remote device 140 may be any device with a remote communication function. In some embodiments, the remote device 140 may include one or more of an appliance, an intelligent doorbell, an anti-theft device, an intelligent lighting, an intelligent curtain. In some embodiments, the remote device 140 may communicate with the intelligent control system 110 bi-directionally. For example, the remote device may receive the control information of the intelligent control system 110, and feedback a result to the intelligent control system 110 after performing a corresponding operation. In some embodiments, the remote device 140 may also initiatively transmit information to the intelligent control system 110 at any time.

The sensor device 150 may be any device that obtains raw data. In some embodiments, the sensor device 150 may include, but is not limited to, one or more of a sound sensor, a temperature sensor, a humidity sensor, a motion sensor, a brightness sensor, and an energy consumption sensor. In some embodiments, the sensor device 150 may transmit the obtained data to the intelligent control system 110. In some embodiments, the intelligent control system 110 may control the acquisition of the sensor device 150. In some embodiments, the sensor device 150 may perform the acquisition at a fixed time interval and transmit the obtained data to the intelligent control system 110. In some embodiments, the sensor device 150 may include a cache module. The cache module may store the obtained data and transmit the stored data to the intelligent control system 110 at a specific time or under a satisfied condition. Further, the sensor device 150 may include a pre-processing module. The pre-processing module may pre-process the obtained data. In some embodiments, the sensor device 150 may only transmit the pre-processed data to the intelligent control system.

In some embodiments, the intelligent control system 110, devices, e.g., the other-device 120, the lighting device 130, the remote device 140, the sensor device 150, etc., and/or modules in each device may need to communicate at the same time period. A method for reducing interference between systems or modules during communication is disclosed in International Patent Application No./(Attorney Docket No.: P1B165273PCT) filed on the same day as the present disclosure. The patent application is incorporated herein by reference.

The above description is only a specific embodiment of the present disclosure and should not be considered as the only embodiment. It is apparent to those skilled in the art that various modifications and variations in form and in detail may be made without departing from the principles and structure of the present disclosure. For example, the sensor device 150 may be included in the lighting device 130, the other-device 120, and the remote device 140, so that the devices may simultaneously detect and transmit data of the devices or other data to the intelligent control system 110 while working normally. For example, the other-device 120 and the remote device 140 may be the same device or devices of the same category. For example, the remote device 140 may be some powered devices including the remote communication module. The other-device 120 may receive remote control of the intelligent control system 110. These modifications and variations are still within the scope of the claims of the present disclosure.

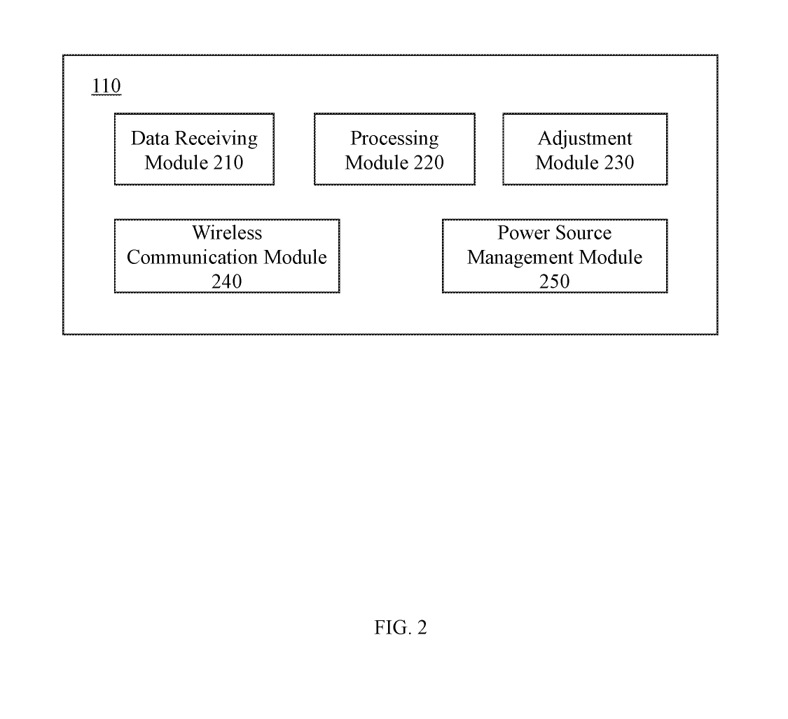

FIG. 2 is a schematic diagram of an intelligent control system according to some embodiments of the present disclosure. The intelligent control system 110 may include a data receiving module 210, a processing module 220, an adjustment module 230, a wireless communication module 240, and a power source management module 250.

The data receiving module 210 may receive data from an external device and other modules in the system. In some embodiments, the data receiving module 210 may receive the data via a wire mode or a wireless mode. In some embodiments, the data receiving module 210 may receive sensor data obtained by the sensor device 150. The sensor data may include one or more of sound data, temperature data, humidity data, motion data, brightness data, and energy consumption data. In some embodiments, the data receiving module 210 may receive feedback information from the external device and transmit the feedback information to the processing module 220. The processing module 220 may analyze the data and determine whether the data includes abnormal data. In some embodiments, the data receiving module 210 may receive data input by a user. For example, the user may adjust the system through an operation interface.

The processing module 220 may be a core control module for data analysis and processing. In some embodiments, the processing module 220 may be interconnected with other modules in the system. In some embodiments, a connection between the processing module 220 and the other modules in the system may be wired or wireless. In some embodiments, the processing module 220 may analyze the data from the data receiving module 210 and detect the abnormal data therein. In some embodiments, the processing module 220 may control and adjust a device with the abnormal data. In some embodiments, the processing module 220 may generate one or more control information (also referred to as control instruction). The control information may be determined based on the data received by the data receiving module 210. In some embodiments, the processing module 220 may control the remote device 140 via the wireless communication module 240. In some embodiments, the processing module 220 may display the data information on the operation interface of the user. In some embodiments, the processing module 220 may include one or more processing units that may be connected to each other. The one or more processing units may communicate or connect with a portion or all of the modules or the devices in the system.

The adjustment module 230 may adjust the operation state of a control device. The adjustment module 230 may include a power adjustment unit and an other-device adjustment unit. In some embodiments, the adjustment module 230 may be connected to the lighting device 130 and the other-device 120. In some embodiments, the connection between the adjustment module 230 and the lighting device 130 and other-device 120 may be wired or wireless. In some embodiments, the adjustment module 230 may adjust the operation state of the device by adjusting a power of the device. For example, lighting brightness may be adjusted by adjusting a power of a lighting device. In some embodiments, the adjustment module 230 may adjust the operation state of the other-device without directly adjusting an input power of the other-device. According to different working characteristics of the other-device 120, the adjustment manner may be different.

The wireless communication module 240 may communicate with the remote device 140 bi-directionally. The remote device 140 may include one or more of an appliance, an intelligent doorbell, an anti-theft device, an intelligent lighting, an intelligent curtain. In some embodiments, the wireless communication module 240 may receive the control information from the processing module 220 and transmit it to the remote device 140, thereby controlling and adjusting the operation state of the remote device 140.

The power source management module 250 may control power supply of other modules in the intelligent control system 110 and devices remote to the system. In some embodiments, the power source management module 250 may include a direct current (DC) to alternating current (AC) ((DC-AC) conversion unit. The DC AC conversion unit may convert a commercial AC into one or more DCs. In some embodiments, the power source management module 250 may include a voltage transformation unit. The voltage transformation unit may obtain different voltages by increasing a voltage or decreasing a voltage. In some embodiments, the power source management module 250 may allocate a required voltage and current according to requirements for a type of the current or a value of the voltage of the different devices or modules.

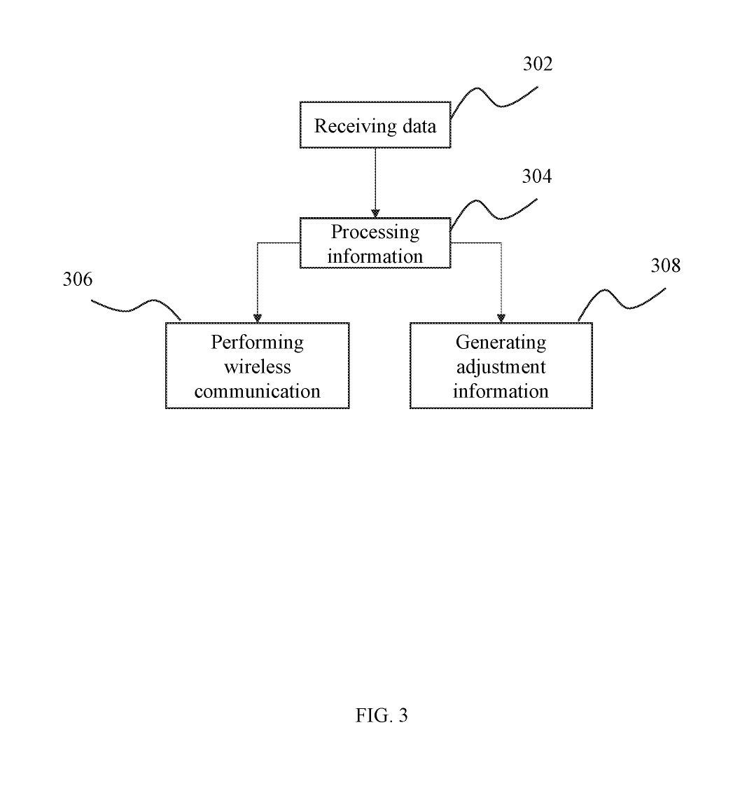

FIG. 3 is a flowchart illustrating an exemplary intelligent control system according to some embodiments of the present disclosure. In operation 302, the intelligent control system may receive one or more pieces of data. The one or more pieces of data may include data of an external device and data of other modules in the system. In some embodiments, the data of the external device may include sensor data obtained by the sensor. The sensor data may include one or more of sound data, temperature data, humidity data, motion data, brightness data, and energy consumption data. In some embodiments, the data of other modules in the system may include operating parameters of other modules, e.g., real-time currents, voltages, powers, temperatures of circuits when the other modules operate. In some embodiments, the one or more pieces of data may also include feedback information of the device.

In operation 304, the intelligent control system may process the data information received in operation 302. In some embodiments, the intelligent control system may generate a control instruction according to the result of the information processing. The control instruction may include a power adjustment instruction, a remote device adjustment instruction, and an other-device adjustment instruction. For example, the control instruction may be control a switch of an air conditioner and adjust a required temperature. For example, the control instruction may adjust the brightness and the switch of the lighting device.

In operation 306, the intelligent control system may transmit the control instruction in operation 304 to the remote device via a wireless communication. In some embodiments, the wireless communication may include, but is not limited to, one or more of a Zigbee technology, a Bluetooth technology, a Z-Wave technology, a Wi-Fi technology, an EnOcean technology.

In operation 308, the intelligent control system may transmit the control instruction in operation 304 to the lighting device and other-devices to adjust the operation state of the device. In some embodiments, an adjustment manner may include power adjustment and other adjustment manners. For example, the lighting brightness may be adjusted by adjusting the power of the lighting device. As another example, an intake amount of heating air may be adjusted by adjusting an open size of an air inlet of heating, thereby adjusting an indoor temperature. According to different working characteristics of the devices, the adjustment manners may be different.

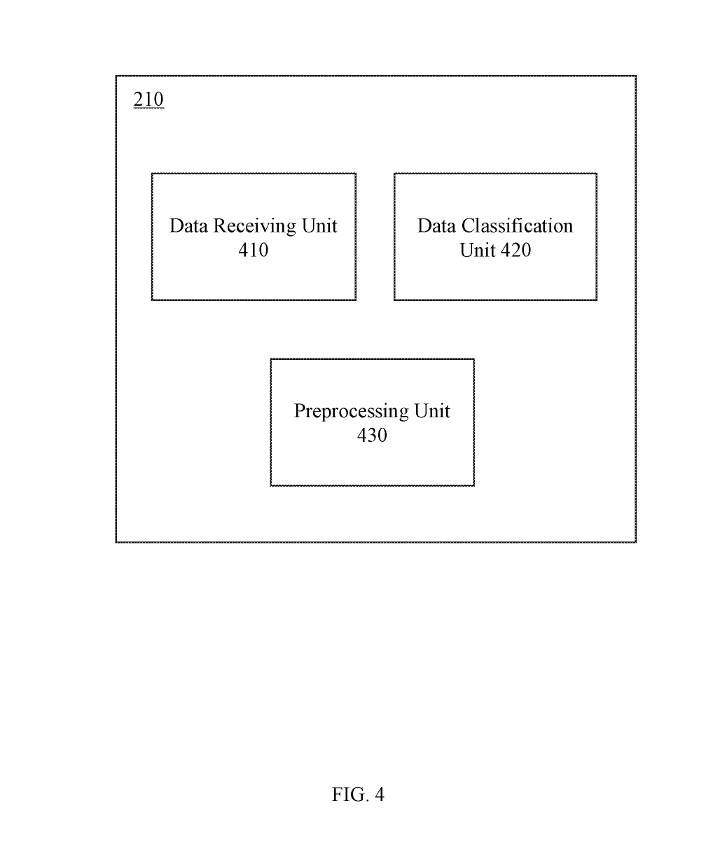

FIG. 4 is a schematic diagram illustrating a data receiving module according to some embodiments of the present disclosure. The data receiving module 210 may include a data receiving unit 410, a data classification unit 420, a preprocessing unit 430, etc.

The data receiving unit 410 may receive data from other modules in the intelligent control system 110 or external devices (e.g., the sensor device 150, the remote device 140, the lighting device 130, the other-device 120, etc.) In some embodiments, the received data may include sound data, temperature data, humidity data, motion data, brightness data, energy consumption data, user input data, or the like. The temperature data may include an ambient temperature or a temperature of one or more devices in the system, or the like. The humidity data may include ambient humidity, or the like. The motion data may include motion information of an object or a human body in the environment. The sound data may include an ambient noise, an abnormal sound, a sound of an acoustic device itself, or the like. The brightness data may include brightness of the environment, a light intensity, an ultraviolet intensity, a position of a light source, or the like. The energy consumption data may include, but is not limited to, total energy consumption data in the system, energy consumption data of each device or module, total energy consumption data of a family, or the like. The user input data may include a temperature, humidity, a timing of a device, lighting brightness, a system working mode, etc., set by the user. In some embodiments, parameter data may be set through an operation interface according to a user habit or a user preference and received by the data receiving unit. The operation interface may be located in the system or remote to the system. The user habit or the user preference may include one or more of an appropriate indoor temperature of the user, a sleep duration, a normal sleep period, a suitable temperature of hot water, a commuting time, or the like.

The data classification unit 420 may classify data according to their respective types. In some embodiments, the data classification unit 420 may classify the data received by the data receiving unit 410. In some embodiments, the received data may include a data tag, respectively. The data classification unit 420 may classify the received data according to the data tag. The data tag may refer to one or more symbols or signs used for distinguishing and indicating data types. In some embodiments, the data tag may be provided by a data source (e.g., the sensor device 150). In some embodiments, the data classification unit 420 may also classify the received data according to other features of the data (e.g., a range, a length, a count, etc., of the data).

The preprocessing unit 430 may preprocess the data. In some embodiments, the preprocessing of the data may include performing a denoising process noise reduction on the data. The denoising process may include removing noise in the data based on a filtering algorithm (e.g., a mean filtering algorithm, a median filtering algorithm, a wiener filtering algorithm, etc.). In some embodiments, for data that is too noisy or data with noise being difficult to remove or reduce by the denoising process, the entire data may be deleted and data may be re-received. In some embodiments, the pre-processing of the data may include clustering the data classified by the data classification unit 420 according to a data type or a data source. Further, the clustered data may be simultaneously transmit to the processing module 220 for subsequent processing. In some embodiments, the pre-processing unit 430 may perform different pre-processing for different types of data. For example, different denoising processing may be used for the different types of data.

In some embodiments, the data receiving module 210 may include a plurality of data receiving units. The plurality of data receiving units may respectively receive specific types of data and respectively preprocess the received specific types of the data.

In some embodiments, the data classified by the data classification unit 420 may be directly transmit to the processing module 220 for subsequent processing without processing by the pre-processing unit 430.

In some embodiments, some operations in the processing module 220 may be implemented in the pre-processing unit 430. For example, the pre-processing unit may preliminarily identify the abnormal data in the data, and feedback and adjust a module or device generating the abnormal data. The abnormal data may refer to data of which a range exceeds a normal range or a predetermined range of a user. In some embodiments, only data that is preliminarily identified as normal may be further transmit to the processing module 220 for subsequent processing, thereby improving the efficiency of processing and storing.

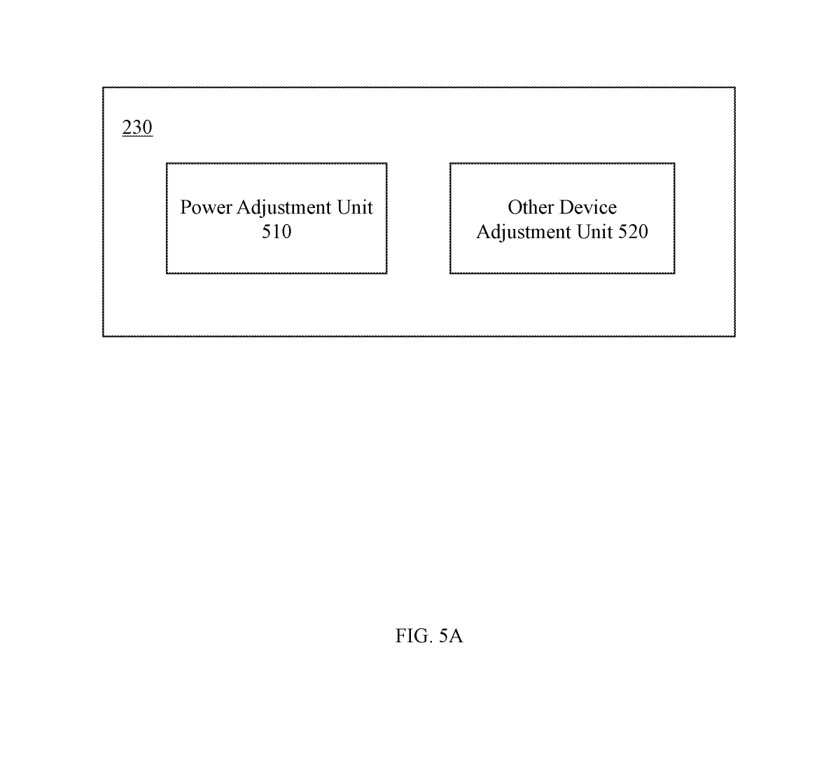

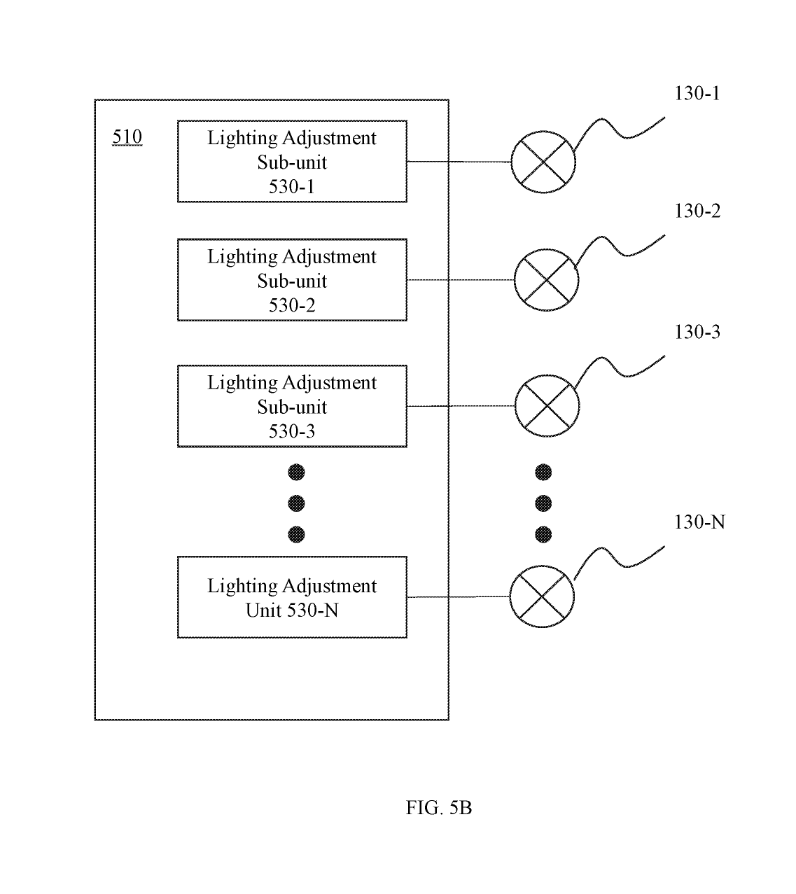

FIG. 5A is a schematic diagram illustrating an adjustment module according to some embodiments of the present disclosure. The adjustment module 230 may include a power adjustment unit 510 and an other-device adjustment unit 520. The power adjustment unit 510 may be connected to one or more devices and change operation of a device by adjusting an input power of the device. For example, the power adjustment unit 510 may be connected with a luminaire. Brightness of the luminaire may be changed by changing an input power of the luminaire. The other-device adjustment unit 520 may be connected to one or more devices and generate a control instruction. The control instruction may be configured to adjust a working mode of the device.

FIG. 5B is a schematic diagram illustrating a power adjustment unit according to some embodiments of the present disclosure. The power adjustment unit 510 may include one or more lighting adjustment sub-units 530. Further, the lighting adjustment sub-unit 530 may be connected to a lighting device 130, respectively. As shown in FIG. 5B, the power adjustment unit 510 may include a plurality of lighting adjustment sub-units 530-1, 530-2, 530-3 . . . 530-N. The lighting adjustment sub-units 530-1, 530-2, 530-3 . . . 530-N may be connected to a plurality of corresponding lighting devices 130-1, 130-2, 130-3 . . . 130-N, respectively.

In some embodiments, the processing module 220 may generate one or more control information to adjust an output power of the lighting adjustment sub-unit 530. In some embodiments, the output power of the lighting adjustment sub-unit 530 may correspond to the input power of the lighting device 130. In some embodiments, the operation state (e.g., brightness, color, etc.) of the lighting device 130 may be related to its input power. Further, by adjusting the output power of the lighting adjustment sub-unit 530, the input power of the lighting device may be adjusted, thereby adjusting the operation state of the lighting device. In some embodiments, the intelligent control system 110 may detect an actual power of the lighting device and determine whether the actual power meets a predetermined power requirement. If the actual power of the lighting device does not meet the predetermined power requirement, the power adjustment unit 510 may be feed backed to further adjust the power until the actual power of the lighting device meets the predetermined power requirement.

In some embodiments, the intelligent control system 110 may determine different time periods and an activity status of a user based on the obtained sensor data received by the data receiving module 210. The lighting device may be adjusted to a corresponding operation state. In some embodiments, the intelligent control system 110 may determine one or more time periods by a timer. The time period may include, but is not limited to, midnight, early morning, morning, dusk, night, late night, one or more specific time points and time periods, etc. In some embodiments, the sensor data may include one or more of sound, light, weight, position, temperature, humidity, pressure, current, speed, acceleration, image, touch, pupil, fingerprint, or the like. For example, the sensor data may include a change of intensities of sun light in the morning, a seasonal change, and a weather change. In some embodiments, the data receiving module may receive data set by the user such as a normal sleep time and a wake-up time. In some embodiments, the processing module 220 may generate one or more deep level data according to the received data, e.g., an emotion and a magnetic field of the user, a sleep depth of the user, etc.

In some embodiments, the method for determining the active state of the user by the intelligent control system 110 may include comparing the obtained information with a specific parameter (e.g., a reference value, a reference range, a threshold, a predetermined value, or a predicted value). A source of the parameter may be set by the user, a predetermined value of the environment control system 110, or obtained by the environment control system 110 based on a trained machine learning model. Parameters from different sources may have different priorities. In the disclosure, when two parameters of different priorities appear at the same time, the system 110 may use a parameter with a higher priority. For example, a parameter input by the user may have a higher priority than a parameter obtained by the system based on the machine training, and the priority of the parameter of the machine training may be higher than the priority of the predetermined value of the system. Further, if the obtained information satisfies a specific parameter requirement (e.g., conforming to a specific reference value, within a specific reference range, exceeding a specific threshold/predetermined value/predicted value, etc.), the processing module 220 may determine that the user is in the corresponding active state. The active state may include sleep (e.g., shallow sleep or deep sleep), a low-intensity activity (e.g., reading, walking, watching TV, etc.) or a high-intensity activity (e.g., exercise, fitness, a party activity, etc.)

After the processing module 220 determines activity state of the user, the adjustment module 230 may adjust the lighting device 130 to a corresponding operation state. The operation state of the lighting device may include a wake-up mode, a sleep mode, or the like. In some embodiments, the adjustment of the wake-up mode and the sleep mode may include using a wake-up mode algorithm or a sleep mode algorithm that conforms to the user habit. The wake-up mode algorithm may include gradually increasing the brightness of the lighting device 130 such that the user gradually wakes up in a natural manner. For example, the wake-up mode algorithm may include gradually increasing the brightness of the lighting device from 0% to 100% depending on the season and/or the weather at the time. (The 0% is the lowest brightness of the lighting device and 100% is the highest brightness of the lighting device). After a time period, the lighting device may be gradually restored to normal indoor brightness. In some embodiments, an event of gradually adjusting the brightness and/or the brightness of the indoor light may also be set by the user. For example, the sleep mode algorithm may gradually dim the intensity of the light of the indoor lighting device to make the user decrease an intensity of the activity and prepare for bed. In some embodiments, the lighting intensity of the lighting device may be gradually reduced from the current light intensity to 0%, and then completely turned off after a buffer time.

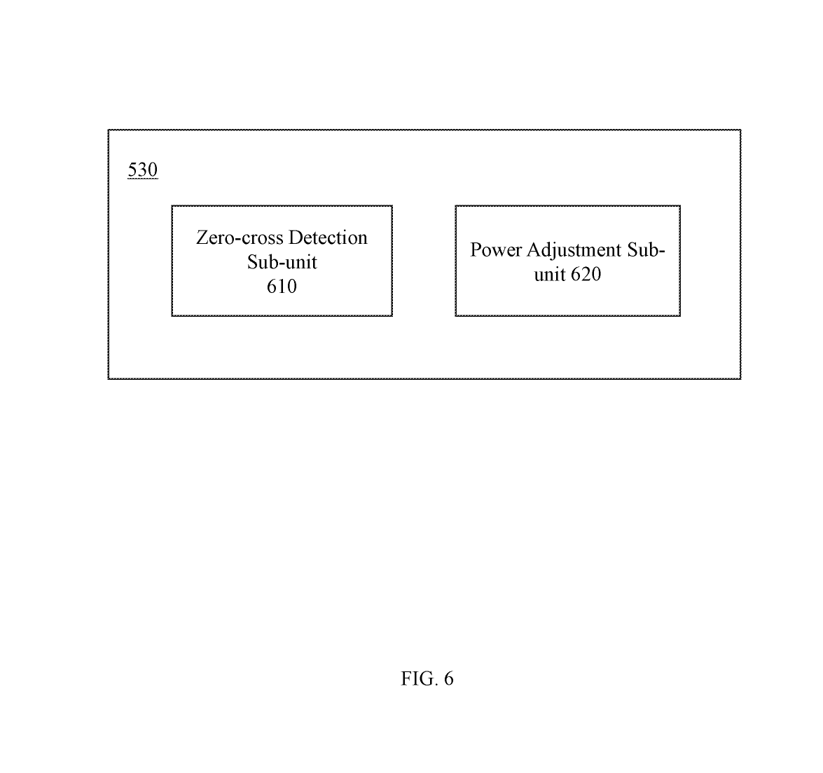

FIG. 6 is a schematic diagram illustrating a lighting adjustment sub-unit according to some embodiments of the present disclosure. The lighting adjustment sub-unit 530 may include a zero-cross detection sub-unit 610 and a power adjustment sub-unit 620. The zero-cross detection sub-unit 610 may detect zero-cross interruption in a circuit. The zero-cross interruption may be a process in which an electrical signal changes from −0 to +0 or from +0 to −0 in an alternating current system, and an interrupt signal may be sent out. In some embodiments, the electrical signal may have a zero-cross interrupt from −0 to +0 and from +0 to −0 in each cycle. A frequency of the electrical signal may be detected by detecting the count and time of zero-cross interruptions in the electrical signal.

The power adjustment sub-unit 620 may adjust an output power of the lighting adjustment sub-unit 530 based on the detection result of the zero-cross detection sub-unit 610, thereby controlling the operation state (such as brightness, etc.) of the lighting device 130. The adjustment method of the brightness in the power adjustment sub-unit 620 may include one or more of a phase-cut dimming method, an analog or digital dimming method, a current limiting dimming method, an inductive ballast sub-power position dimming method, a variable resistance dimming method, a pulse duty cycle dimming method, a pulse frequency modulation dimming method, an adjusting high frequency inverter supply voltage dimming method, a pulse phase modulation dimming method, a sine wave dimming method, and a dimming method of changing a series inductance value. A method for adjusting the brightness is disclosed in International Patent Application No. (Attorney Docket No.: P1B165270PCT) filed on the same day as the present disclosure, which is incorporated herein by reference.

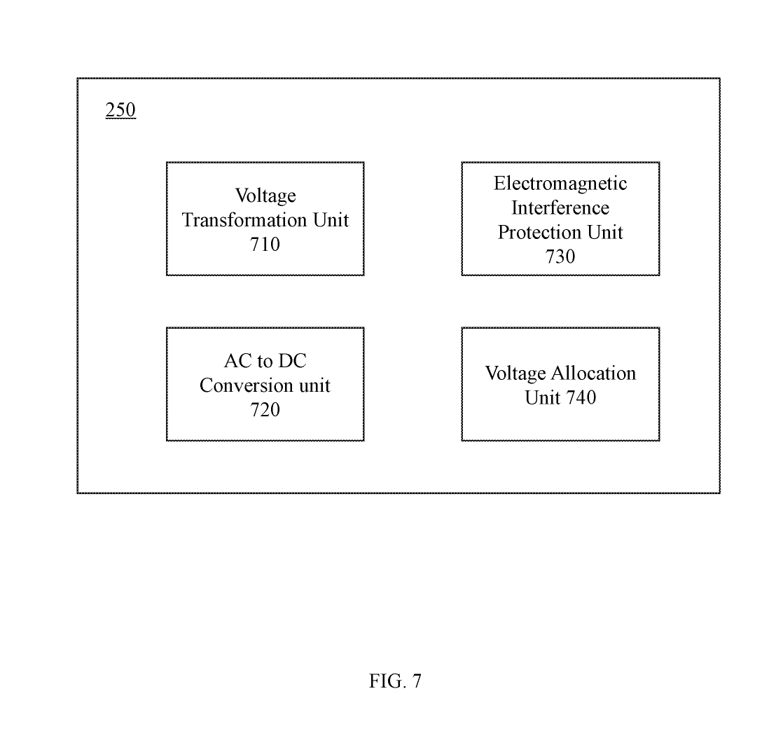

FIG. 7 is a schematic diagram illustrating a power source management module according to some embodiments of the present disclosure. The power source management module 250 may include a voltage transformation unit 710, an AC to DC conversion unit 720, an electromagnetic interference protection unit 730 and a voltage allocation unit 740.

The voltage transformation unit 710 may decrease or increase a voltage of an input electrical signal so that different voltages after processing may meet voltage requirements of different devices. In some embodiments, the voltage transformation unit 710 may decrease or increase the voltage of the input electrical signal for multiple times to meet the voltage requirements of the different devices. For example, the voltage transformation unit 710 may first convert a 220V/110V input electrical signal into 7V. Then the voltage transformation unit 710 may convert a signal of 7V to a signal of 5V and a signal of 3.3V, thereby meeting power requirements of devices with voltage requirements of 3.3V, 5V, 7V and 220V/110V.

The AC-DC conversion unit 720 may convert a form of the input electrical signal into a required direct current or alternating current according to the requirements of the different devices. In some embodiments, the AC to DC conversion unit 720 may include converting a DC input electrical signal into an AC electrical signal by an inverter, or the like. In some embodiments, the AC-DC conversion unit 720 may include converting an AC input electrical signal into a DC signal by a rectifier, or the like.

The electromagnetic interference unit 730 may reduce interference caused by an effect of an electromagnetic wave and an electronic component. The voltage allocation unit 740 may allocate the converted and transformed voltage to each module or device so that all devices and modules may work normally. In some embodiments, the voltage allocation unit 740 may include a detection circuit. The detection circuit may measure and rectify voltages of other modules in the intelligent control system 110, the lighting device 130, the other-device 120, the remote device 140, the sensor device 150, etc.

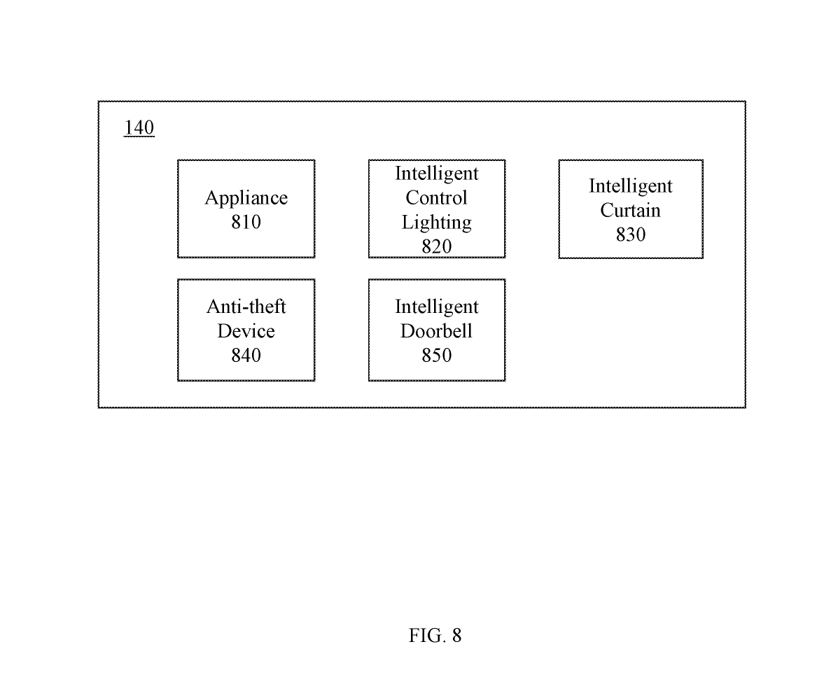

FIG. 8 is a schematic diagram illustrating a remote device according to some embodiments of the present disclosure. The remote device 140 may include, but is not limited to, an appliance 810, an intelligent control lighting 820, an intelligent curtain 830, an anti-theft device 840, and an intelligent doorbell 850. In some embodiments, the remote device 140 may communicate with the intelligent control system 110 wirelessly (e.g., via the wireless communication module 240). In some embodiments, the adjustment module 230 may control the remote device 140 through the wireless communication module 240. For example, the data receiving module 210 may receive one or more sensor data. The sensor data may be analyzed in the processing module 220 to generate a control instruction. The control instruction may be transmitted to the remote device 140 and configured to control the remote device 140. For example, when the data receiving module 210 receives related data that the indoor brightness decreases in the evening, the intelligent control system may control to open of the intelligent curtain 830. The intelligent control system may control to close of the intelligent curtain 830 when the indoor brightness is too large during noon or afternoon.

In some embodiments, the intelligent control system 110 may communicate with the remote device 140 via the wireless communication module 240 to implement a home control function. For example, through the communication with an electric lamp and a socket, the brightness control of the electric lamp and the socket may be implemented. Through the communication with an intelligent door lock, the control of the door lock and an automatic arming/defending function may be realized. Through the communication with an infrared/Bluetooth relay module in the home, the control of electrical devices with infrared/Bluetooth remote control function may be implemented. Through the connection with a public telephone line, the remote telephone control may be implemented. Through interconnection with an electronic device (such as a tablet computer, a mobile phone, a computer, etc.) inside the home, the control of the entire system may be implemented through the electronic device. Through the connection with a home internal telephone and the connection with a public switched telephone network, respectively, the user's home may be controlled at any position internally (using a wireless telephone extension) and remotely controlled. For example, when the user is outside, an indoor theft occurs, and an alarm system is triggered, alarm information may be transmit to the user's mobile phone, a security company, a local police station, etc.

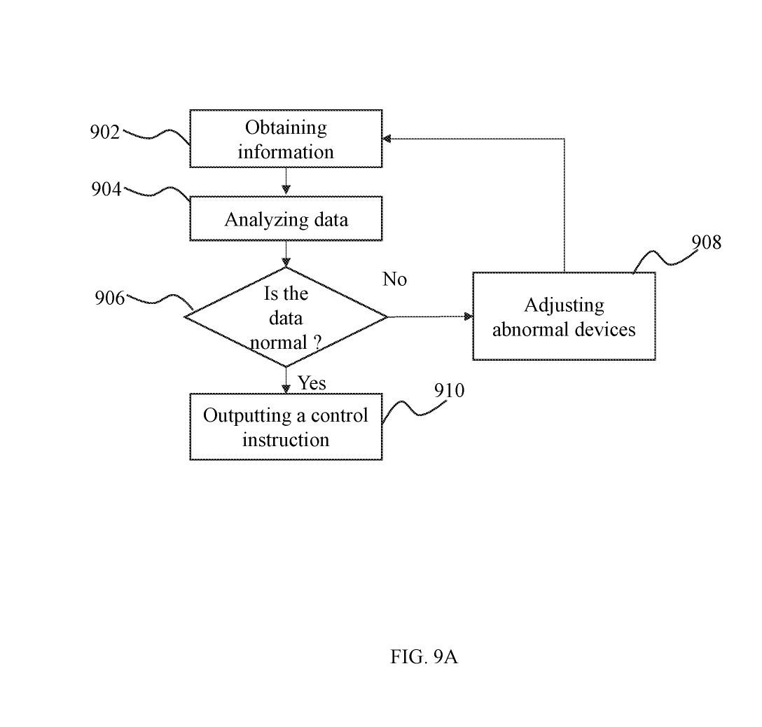

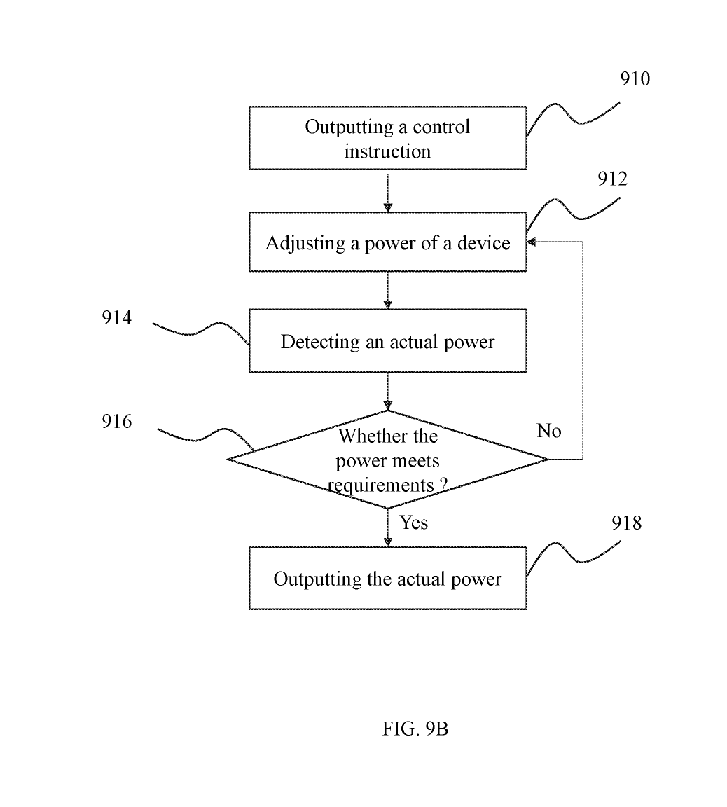

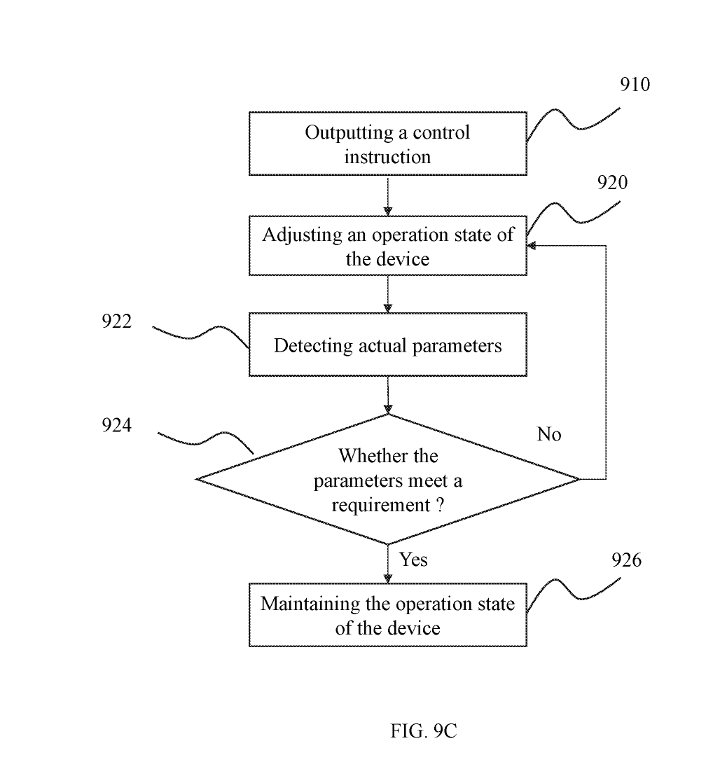

FIG. 9A is a flowchart illustrating an exemplary process for generating a control instruction based on obtained data according to some embodiments of the present disclosure. Operation 902 may include obtaining one or more pieces of data information. The one or more pieces of data information may include data information of an external device and data information of other modules in the system. In some embodiments, the data of the external device may include sensor data obtained by the sensor device 150. The sensor data may include one or more of sound data, temperature data, humidity data, motion data, brightness data, and energy consumption data. In some embodiments, the data of other modules in the system may include operating parameters of other modules, such as a current, a voltage, a power, a temperature at which each module operates, or the like. In some embodiments, the one or more pieces of data may also include feedback information of the device or module.

Operation 904 may include analyzing and processing the obtained data information. In some embodiments, the data analysis and processing method may include performing statistics, calculating, filtering, sorting, clustering, etc., on the data. For example, power data may be obtained based on current data and voltage data. In some embodiments, the data analysis and processing method may further include performing denoising, smoothing, etc., on information.

Operation 906 may include determining whether there is abnormal data based on the analyzed data. In some embodiments, the determination may include determining whether the data is within a normal range, whether the data satisfies a requirement set by a user, whether the data is missing, or the like. For example, if a measured ambient temperature is greater than a normal operating temperature range of the system, the temperature data may include an alert that the temperature is too high (an anomaly occurs) and corresponding adjustment may be implemented. If there is abnormal data, process 900 may proceed to operation 908. If all of the data is normal, process 900 may proceed to operation 910.

Operation 908 may include adjusting a device with one or more abnormal data. In some embodiments, the abnormal device may be adjusted by feedback until detected data is within a reasonable range. For example, an operating temperature of the system circuit may be monitored real-time. When the temperature is too high or too low, the corresponding device may be adjusted in real-time. For example, a temperature may be adjusted within a normal working range of a circuit by decreasing a power of a high-power device or by a cooling system of a fan.

Operation 910 may include outputting a control instruction based on the analyzing and processing result. In some embodiments, the control instruction may include a power adjustment instruction, a remote device adjustment instruction, an other-device adjustment instruction, etc. In some embodiments, the control instruction may be transmit to the adjustment device by wire or wirelessly. For example, the control instruction may be transmit to an air conditioner by wire or wirelessly to control a switch, an air supply time or an intensity of the air supply of the air conditioner, etc. The control instruction may be inputted to the lighting device by a wired or wireless mode to adjust the switch, brightness of the lighting device, etc.

FIG. 9B is a flowchart illustrating exemplary power adjustment according to some embodiments of the present disclosure. Operation 912 may include adjusting a power of a device according to a control instruction. In some embodiments, a method for adjusting the power of the device may include a method for controlling an input current, a method for controlling an input voltage, a phase-cutting method, or the like, or a combination thereof. In some embodiments, the power adjustable device may include a lighting, an electric fan, an air conditioner, a humidifier, or the like.

Operation 914 may include receiving an actual power of the device. In some embodiments, the actual power may be directly detected by an energy consumption sensor. In some embodiments, the voltage and/or the current may be detected by a current voltage sensor and then a real-time power may be obtained by a calculation method. See a method for detecting an electrical power as described in International Patent Application No. (Attorney Docket No.: P1B165272PCT), entitled “Electric Power Control System and Method”, filed on the same day as the present disclosure. This patent application is incorporated herein by reference in its entirety. In some embodiments, the device itself may include a power detection module that may detect the power of the device and the power may be received in operation 914. In some embodiments, the actual power may include an actual power of the entire device and/or the actual power of one or more components in the device.

Operation 916 may determine whether the detected actual power meets the requirements. In some embodiments, the actual power may be too large or too small, which may affect an operation state and a service life of the device. For example, if a power of an illuminator is too large, brightness may exceed a normal operation range. If a working time is too long, a heat of the bulb may accumulate, which may cause damage to the bulb. If the actual power does not meet the requirements, the process 900 may return to operation 912 to re-adjust the power. If the actual power meets the requirements, the actual power may be output to the device in operation 918.

FIG. 9C is a flowchart illustrating exemplary other-device adjustment according to some embodiments of the present disclosure. Operation 920 may include adjusting an operation state of other-devices according to an adjustment instruction. The other-device may include a device that does not perform power control, but a device with switching control or working mode control. For example, the other-device may include a boiler control device, a heating control device, a water tank level adjustment device, an intelligent door lock, an intelligent curtains, etc.

Operation 922 may include receiving an actual operating parameter of the device. In some embodiments, the actual operating parameter of the device may be received through the sensor device 150. For example, the actual operating parameter of the device may be received by different sensors (e.g., a temperature sensor, a humidity sensor, a sound sensor, a brightness sensor, an energy consumption sensor, etc.). In some embodiments, the actual working parameter of the device may include a parameter of the device itself and a parameter within the working environment.

Operation 924 may include determining whether the actual operating parameter of the received device meets the requirements. In some embodiments, if the actual operating parameter of the device is abnormal, the normal operation of the device may be affected or a user experience may be affected. The actual operating parameter of the device may need to be re-adjusted in operation 912. For example, through the adjustment of an intake amount of heating air in winter, an indoor temperature may be controlled at 16-24 degrees Celsius. When the temperature is too high or too low, the user experience may be poor. Through the temperature data received by the indoor temperature sensor, an intake valve of heating air may be adjusted, and the intake amount of the heating air may be reduced or increased, thereby increasing or decreasing the indoor temperature, and maintaining the room temperature between 16-24 degrees Celsius. In some embodiments, the actual operating parameter of the device may include data whether the received environment includes a moving object or a human body. For example, when the motion sensor receives data that the environment does not include a human activity, the lighting device or the air conditioner, etc., may be turned off. When the motion sensor detects an abnormal human activity in a certain time period, an anti-theft device (e.g., an anti-theft doorbell, an alarm, etc.) may be turned on. If all of the actual working parameters of the device are normal, the operation state of the device may be maintained in operation 926.

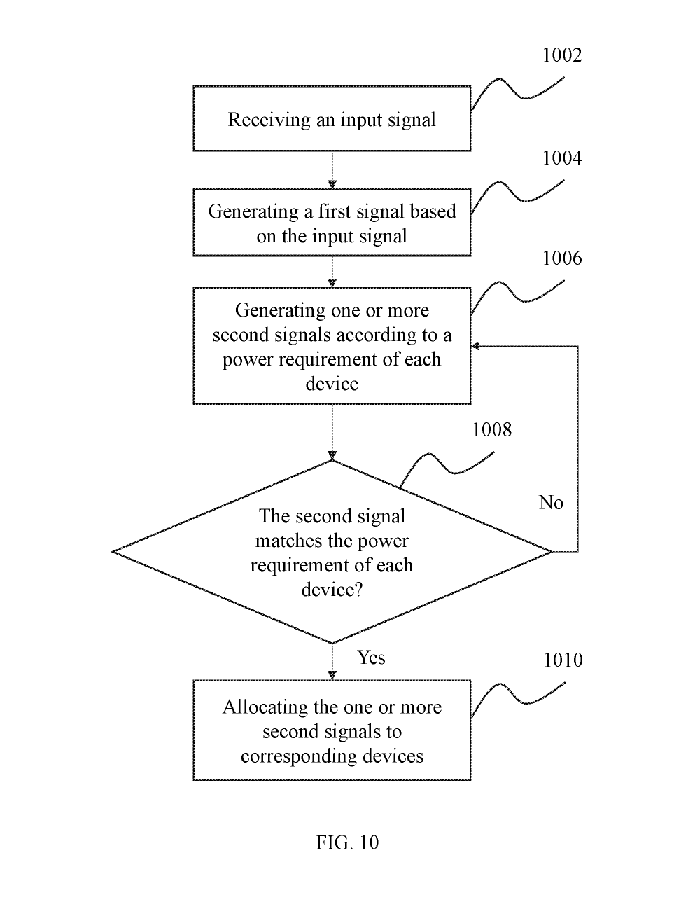

FIG. 10 is an exemplary flowchart illustrating an exemplary power management module according to some embodiments of the present disclosure.

Operation 1002 may include receiving an input signal. The input signal may be an AC signal from a domestic grid. Further, a voltage of the input signal may be 220V/110V, and a frequency may be 50 HZ. In some embodiments, a waveform of the input signal may be a DC wave, a sine wave, a square wave, a triangular wave, other waveforms, or the like.

Operation 1004 may include converting the input signal to a first signal. In some embodiments, the first signal may be a DC signal. Further, operation 1004 may include converting the input AC signal to a DC signal. In some embodiments, a conversion method may include, but is not limited to, rectification, filtering, or the like. In some embodiments, the conversion may be implemented by the AC-DC conversion unit 720.

Operation 1006 may include generating one or more second signals according to a power requirement of each device. Each device may include a module or a unit in the intelligent control system 100, a device remote to the system, or the like. In some embodiments, the power requirement of the device may include a requirement of a voltage, a current type, and a power. The generation of the one or more second signals may be implemented by the voltage transformation unit 710.

Operation 1008 may include determining whether the second signal corresponds to the power requirement of each device. If not, the process 100 may return to operation 1006 to adjust or regenerate the second signal. Otherwise, one or more second signals may be allocated to corresponding devices in operation 1010. The allocation of the second signal may be implemented by the voltage allocation unit 740.

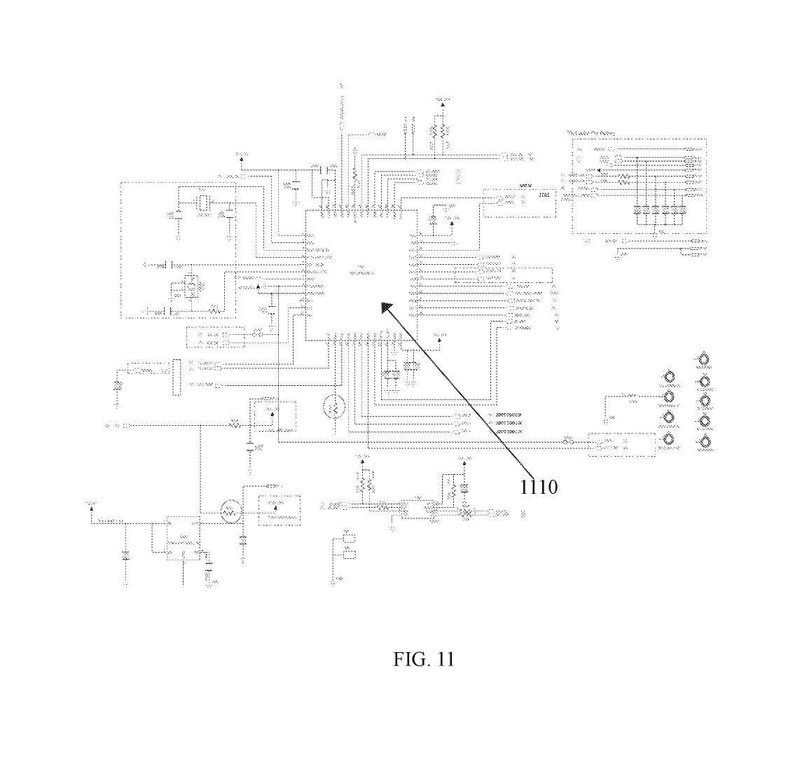

FIG. 11 is a circuit diagram illustrating a processing module according to some embodiments of the present disclosure. As shown in FIG. 11, a module 1110 may be a part of the processing module, and an operation mode and a working principle thereof, etc., may be found in the corresponding description of the processing module 220 in FIG. 2.

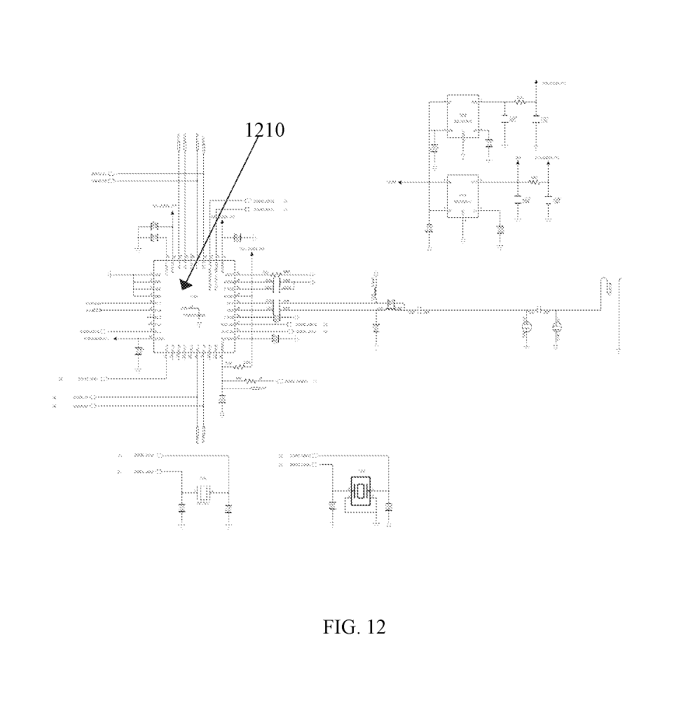

FIG. 12 is a circuit diagram illustrating a wireless communication module according to some embodiments of the present disclosure. As shown in FIG. 12, a module 1210 may be a wireless communication module, and an operation mode and a working principle thereof, etc., may be found in the corresponding description of the wireless communication module 240 in FIG. 2.

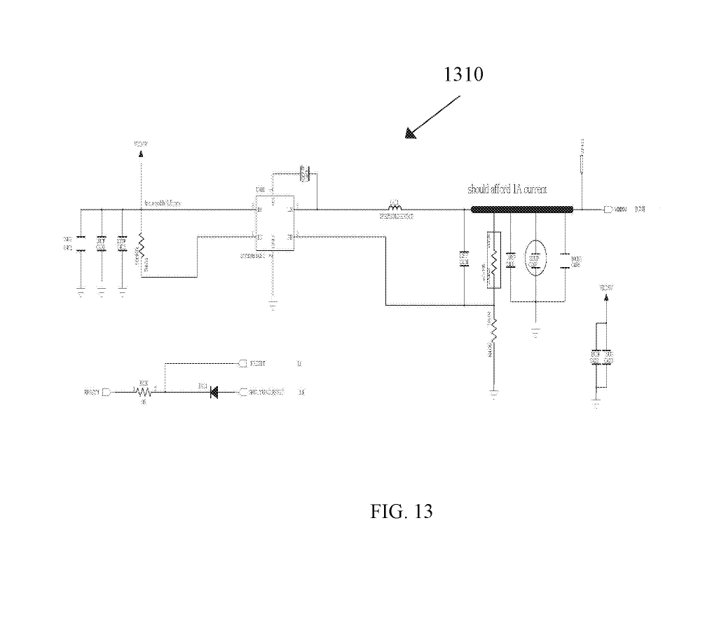

FIG. 13 is a circuit diagram illustrating a power source management module according to some embodiments of the present disclosure. As shown in FIG. 13, a module 1310 may be a part of the power source management module, and an operation mode and a working principle thereof, etc., may be found in the corresponding description of the power source management module 250 in FIG. 2.

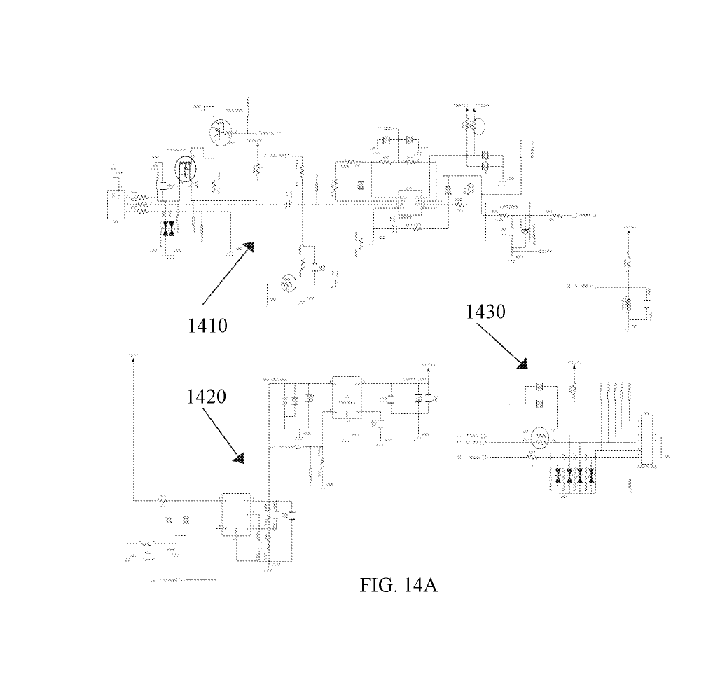

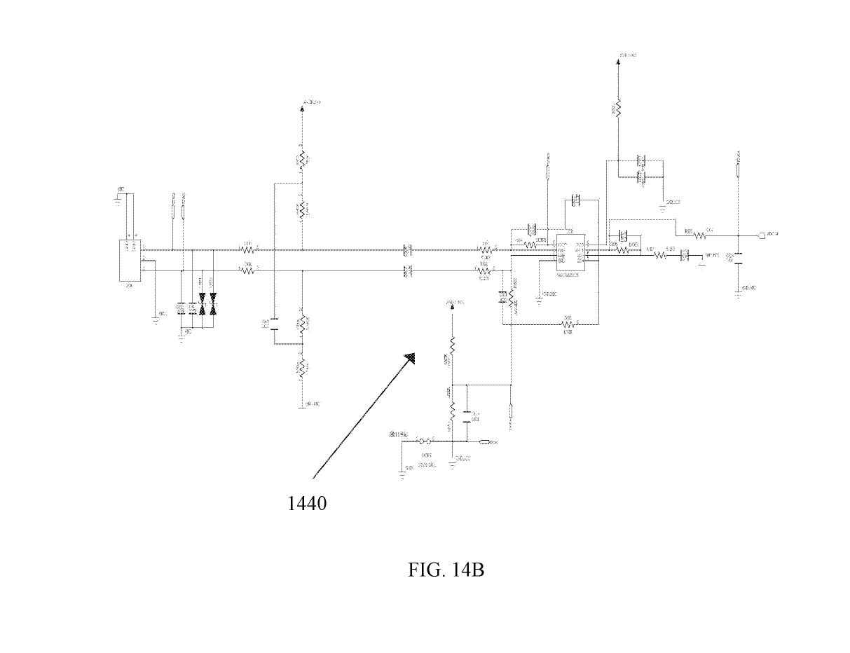

FIG. 14A is a circuit diagram illustrating a sensor device according to some embodiments of the present disclosure. As shown in FIG. 14A, modules 1410, 1420, and 1430 may be three different sensor devices, and their operation modes and working principles, etc., may be found in other parts of the document, e.g., the corresponding description of the sensor device 150 in FIG. 1.

FIG. 14B is a circuit diagram illustrating a sensor device according to some embodiments of the present disclosure. As shown in FIG. 14B, a module 1440 may be a sensor device, and an operation mode and a working principle thereof, etc., may be found in other parts of the document, e.g., the corresponding description of the sensor device 150 in FIG. 1.

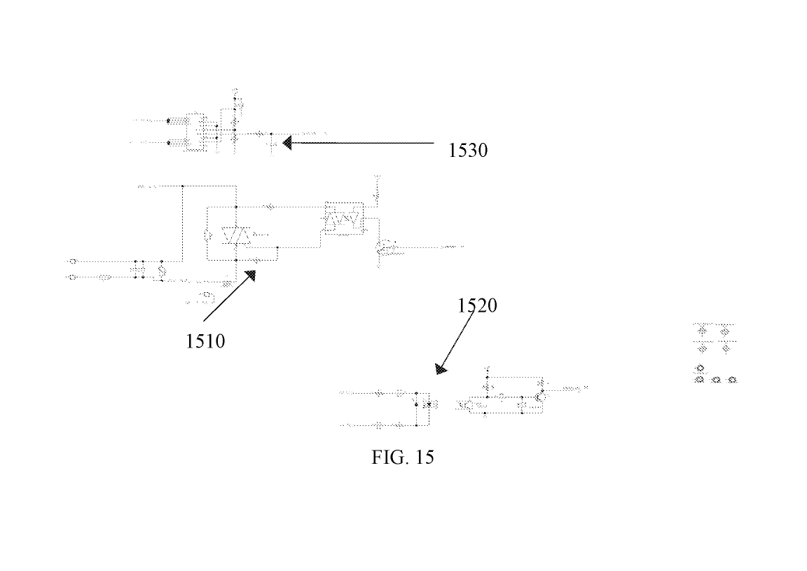

FIG. 15 is a circuit diagram illustrating a power source management module and an adjustment module according to some embodiments of the present disclosure. As shown in FIG. 15, a module 1530 may be a part of the power source management module, and an operation mode and a working principle thereof, etc., may be found in other parts of the document, e.g., the corresponding description of the power source management module 250 in FIG. 2. Modules 1510 and 1520 may be part of the adjustment module, respectively. Their operation modes and working principles may be found in other parts of this paper, e.g., the corresponding description of the adjustment module 230 in FIG. 2.

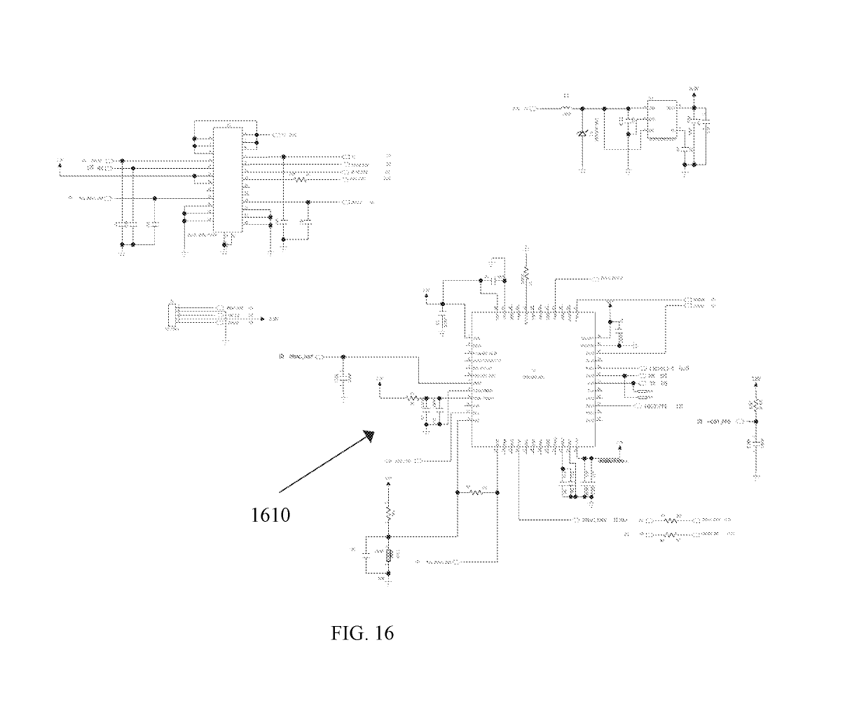

FIG. 16 is a circuit diagram illustrating an exemplary processing module according to some embodiments of the present disclosure. As shown in FIG. 16, a module 1610 may be a part of the processing module, and an operation mode and a working principle thereof, etc., may be found in other parts of this document, e.g., the corresponding description of the processing module 220 in FIG. 2.

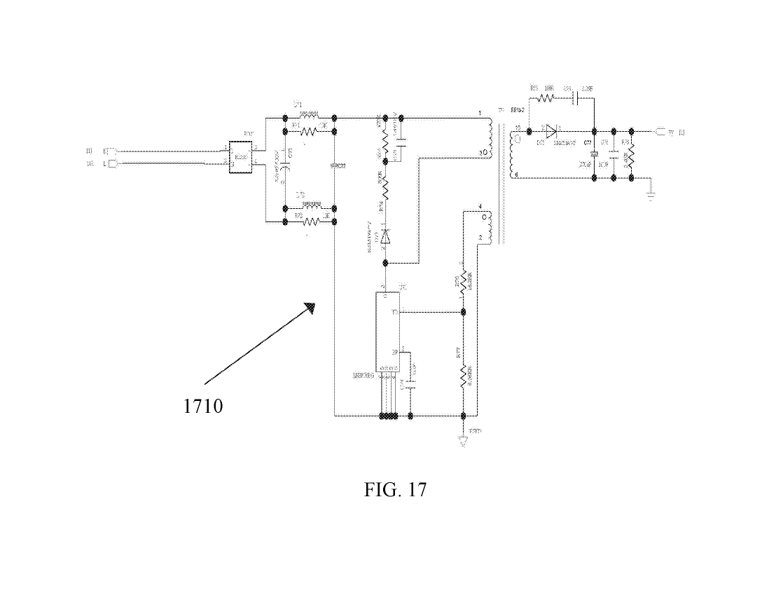

FIG. 17 is a circuit diagram illustrating a power source management module according to some embodiments of the present disclosure. As shown in FIG. 17, a module 1710 may be a part of the power source management module, and an operation mode and a working principle thereof, etc., may be found in other parts of this paper, e.g., the corresponding description of power source management module 250 in FIG. 2.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic found in the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” Unless otherwise stated, “about”, “approximately” or “substantially” indicates that the number may have a variation as described. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system comprising:
a data receiving module, the data receiving module configured to receive data, and the data being related to operation of a first device;
a processing module, the processing module configured to process the data to produce processed data;
an adjustment module, the adjustment module configured to generate a control instruction according to the processed data, wherein the control instruction adjusts the operation of the first device; and
a power source management module, the power source management module configured to manage a power source of a first module or a power source the first device in the system.

2. The system of claim 1, wherein the data received by the data receiving module is from a sensor.

3. The system of claim 2, wherein the sensor includes a sound sensor, a temperature sensor, a humidity sensor, a motion sensor, a brightness sensor or an energy consumption sensor.

4. The system of claim 3, wherein the temperature sensor measures a temperature of the first module or a temperature of the first device in the system.

5. The system of claim 1, wherein the first module includes the processing module, the adjustment module, or the data receiving module.

6. The system of claim 1, wherein the first device includes one or more of: a humidifier, an air conditioner, an electric fan, an LED lamp, a mercury lamp, a halogen lamp, a metal halide lamp, and an incandescent lamp.

7. The system of claim 1, wherein the power source management module provides a required voltage to the first module or the first device.

8. The system of claim 1, wherein the adjustment module further includes a power adjustment unit, the power adjustment unit configured to change the operation of the first device by adjusting an input power of the first device.

9. The system of claim 1, wherein the adjustment module further includes an other-device adjustment unit, the other-device adjustment unit configured to generate a second control instruction, and the second control instruction adjusting an operation mode of the second device.

10. The system of claim 9, wherein the second device includes an electrical appliance, an intelligent doorbell, an anti-theft device, an intelligent lighting device, an intelligent curtain, a boiler control device, a heating control device, a water tank level adjustment device, or an intelligent door lock.

11. The system of claim 9, further comprising:
a wireless communication module, the wireless communication module configured to communicate wirelessly with the first device or the second device.

12. A method, comprising:
receiving data by a data receiving module, the data being related to operation of a first device;
processing the data to produce processed data by a processing module;
generating a control instruction based on the processed data by an adjustment module, wherein the control instruction adjusts the operation of the first device; and
managing a power source of a first module or a power source of the first device by a power source management module.

13. The method of claim 12, wherein the first module includes the processing module, the adjustment module, or the data receiving module.

14. The method of claim 12, wherein the data receiving module configured to receive data from a sensor.

15. (canceled)

16. (canceled)

17. The method of claim 12, wherein the first device includes one or more of: a humidifier, an air conditioner, an electric fan, an LED lamp, a mercury lamp, a halogen lamp, a metal halide lamp, and an incandescent lamp.

18. The method of claim 12, wherein the power source management module configured to provide a required voltage to the first module or the first device.

19. The method of claim 12, wherein the adjustment module further includes a power adjustment unit, the power adjustment unit configured to change the operation of the first device by adjusting an input power of the first device.

20. The method of claim 12, wherein the adjustment module further includes an other-device adjustment unit, the other-device adjustment unit configured to generate a second control instruction, and the second control instruction adjusting an operation mode of the second device.

21. (canceled)

22. The method of claim 20, further comprising communicating wirelessly with the first device or the second device by a wireless communication module.

23. A computer readable storage medium, storing executable instructions that cause a computer device to perform:
receiving data by a data receiving module, the data being related to operation of a first device;
processing the data to produce processed data by a processing module;
generating a control instruction based on the processed data by an adjustment module, wherein the control instruction adjusts the operation of the first device; and
managing a power source of a first module or a power source of the first device by a power source management module.
